(19) United States
(12) Patent Application Publication
(10) Pub. No.: US 2026/0288219 A1
(43) Pub. Date: Sep. 24, 2026

(54) POWER SUPPLY MONITORING

(71) Applicant: Infineon Technologies AG, Neubiberg (DE)

(72) Inventors: Bernd Zimek, Graz (AT); Ralf-Rainer Schledz, Raab (AT)

(21) Appl. No.: 19/462,378

(22) Filed: Jan. 28, 2026

(30) Foreign Application Priority Data
Jan. 29, 2025 (DE) 102025103300.5

(51) Int. Cl. G06F 1/28; G06F 1/30

(52) U.S. Cl. CPC G06F 1/28; G06F 1/305

(57) ABSTRACT

A method for monitoring a power supply configured to provide a supply voltage and for monitoring a bandgap circuit configured to generate a substantially fixed reference voltage using the supply voltage is disclosed. The method includes: providing an output voltage equal to the smaller of the reference voltage multiplied by a gain value and the supply voltage; responsive to the output voltage meeting a trigger value, providing first information indicating that the reference voltage meets a reference threshold value, and the supply voltage meets a supply threshold value; and responsive to the output voltage failing to meet the trigger value, providing second information indicating that the reference voltage fails to meet the reference threshold value or the supply voltage fails to meet the supply threshold value.

### CROSS-REFERENCE TO RELATED APPLICATIONS

This application claims the benefit of German Patent Application No. 102025103300.5, filed on Jan. 29, 2025, which application is hereby incorporated herein by reference.

### TECHNICAL FIELD

The present disclosure generally relates to monitoring a power supply, and more particularly to monitoring a power supply and a bandgap circuit.

### BACKGROUND

For many systems, it is important to ensure that a power supply is providing a voltage that meets a minimum required threshold to ensure proper and safe operation of the system. This can be particularly challenging for single-supply systems, as the circuitry used for monitoring the power supply is often itself powered by the power supply. As a result, in certain conditions, the monitoring circuitry may not provide a reliable indication of the state of the power supply.

For example, the supply voltage provided by the power supply may need to meet a threshold. To ensure this, the supply voltage may be compared to a reference voltage. Whilst it may be the case that the reference voltage can be generated in a wide array of operating conditions of the power supply, it typically cannot be guaranteed in all cases. Indeed, the circuit generating the reference voltage may require a minimum supply voltage, the circuit itself be faulty, or the circuit may require time to properly start up and provide a stable output. Of course, the reference voltage itself may be subject to monitoring circuitry, but this adds further cost and suffers from the same issues as monitoring circuitry used for the power supply.

Accordingly, there exists a need for improved means for reliably monitoring a power supply.

### SUMMARY

According to one aspect, there is provided a circuit for monitoring a power supply and a bandgap circuit. The power supply is configured to provide a supply voltage. The bandgap circuit is configured to generate a substantially fixed reference voltage using the supply voltage.

The circuit comprises a gain component configured to receive the reference voltage and the supply voltage, and to provide an output voltage equal to the smaller of the reference voltage multiplied by a gain value, and the supply voltage. Additionally, the circuit comprises a comparison circuit configured to provide first information indicating that the reference voltage meets a reference threshold value and that the supply voltage meets a supply threshold value, responsive to the output voltage meeting a trigger value. The comparison circuit is configured to provide second information indicating that either the reference voltage fails to meet the reference threshold value, and/or the supply voltage fails to meet the supply threshold value, responsive to the output voltage failing to meet the trigger value.

According to a further aspect of the present disclosure, a method for monitoring a power supply and a bandgap circuit is provided. The power supply is configured to provide a supply voltage and the bandgap circuit is configured to generate a substantially fixed reference voltage using the supply voltage.

The method comprises providing an output voltage equal to the smaller of the reference voltage multiplied by a gain value and the supply voltage. Responsive to the output voltage meeting a trigger value, the method provides first information indicating that the reference voltage meets a reference threshold value, and the supply voltage meets a supply threshold value. Responsive to the output voltage failing to meet the trigger value, the method provides second information indicating that either the reference voltage fails to meet the reference threshold value, and/or the supply voltage fails to meet the supply threshold value.

Those skilled in the art will recognize additional features and advantages upon reading the following detailed description, and upon viewing the accompanying drawings.

### BRIEF DESCRIPTION OF THE DRAWINGS

The invention will now be described by way of example with reference to the accompanying drawings, in which:

FIG. 1 presents a prior art circuit for monitoring a power supply and a bandgap circuit;

FIG. 2 presents a circuit for monitoring a power supply and a bandgap circuit according to an embodiment;

FIG. 3 depicts an example response of the circuit of FIG. 2 during a fast start-up of the power supply or slow start-up of the bandgap circuit;

FIG. 4 depicts an example response of the circuit of FIG. 2 during a slow start-up of the power supply;

FIG. 5 presents a circuit for monitoring a power supply and a bandgap circuit according to a further embodiment;

FIG. 6 presents a circuit diagram of an open loop bandgap (OLBG) circuit according to an aspect of embodiments; and

FIG. 7 presents a flow diagram of a method for monitoring a power supply and a bandgap circuit.

It should be noted that these figures are diagrammatic and not drawn to scale. Relative dimensions and proportions of parts of these figures have been shown exaggerated or reduced in size, for the sake of clarity and convenience in the drawings.

### DETAILED DESCRIPTION OF ILLUSTRATIVE EMBODIMENTS

The following description sets forth exemplary aspects of the present disclosure. It should be recognized, however, that such description is not intended as a limitation on the scope of the present disclosure. Rather, the description also encompasses combinations and modifications to those exemplary aspects described herein.

The disclosed concepts relate to monitoring of a power supply and a bandgap circuit powered by the power supply. Specifically, embodiments relate to the monitoring of a magnitude of the supply voltage produced by the power supply, and a magnitude of the substantially fixed reference voltage produced by the bandgap circuit. To this end, an output voltage is produced equal to the smaller of reference voltage multiplied by a gain value, and the supply voltage. If the output voltage is equal to or greater than a trigger value, then it is determined that both (i) the reference voltage meets a reference threshold value; and (ii) the supply voltage meets a supply threshold value. Alternatively, if the output voltage is less than the trigger value, then it is determined that either (or both) (i) the reference voltage fails to meet the reference threshold value; and (ii) the supply voltage fails to meet the supply threshold value.

In other words, if the smallest of the reference voltage multiplied by the gain and the supply voltage fails to meet a trigger value, then it is deduced that at least one of the reference voltage and the supply voltage fall below their predefined thresholds. This therefore provides a simple way to infer whether at least one of the power supply and the bandgap circuit is failing to produce an adequate voltage (e.g., due to a damage, a fault, unusual operating conditions, etc.). This information may then be used to decide whether to start a system to be powered by the power supply, to inform a user or a system to perform further diagnostics, or inform a system or a user to fix a problem.

To be clear, the bandgap circuit is a voltage reference circuit that produces a near-constant voltage using the supply voltage. That is, regardless of potential fluctuations of the power supply, electrical load, temperature, etc., the bandgap circuit may produce a near-constant voltage. Accordingly, a bandgap circuit may be used to determine whether a power supply provides a supply voltage that meets a threshold value (e.g., by comparison between the reference voltage produced by the bandgap circuit and the supply voltage).

However, the reference voltage may be incorrect at start up of the bandgap circuit (i.e., it may be unstable for a time after the bandgap circuit is initially turned-on/powered). Further, if the supply voltage is excessively low, then the reference voltage may be unstable. In addition, if the bandgap circuit is damaged, such as from excessive heating, exposure to an overcurrent, or subject to excessive force, then the bandgap circuit may output an unexpected reference voltage. Thus, there may be some circumstances where the bandgap circuit produces an unexpected reference voltage. There may therefore be a chance that monitoring the supply voltage based on the reference voltage is incorrect. In other words, monitoring based on the reference voltage produced by a bandgap circuit may be unreliable.

Accordingly, the proposed embodiments combine the comparison of the supply voltage and the reference voltage to a trigger level. If either the reference voltage scaled by a gain value, or the supply voltage, fails to meet the trigger value then it can be deduced that one of the supply voltage or the reference voltage does not meet their respective thresholds.

This disclosure therefore provides a circuit for monitoring a power supply configured to provide a supply voltage. The power supply may be any electrical device configured to provide electrical power to an electrical load. The power supply provides a supply voltage that ideally has a magnitude within a predetermined range, although this may be subject to the connected load and other operating conditions of the power supply. The supply voltage may provide a direct voltage, being substantially stable over time (i.e., non-alternating).

The circuit also monitors a bandgap circuit configured to generate a substantially fixed reference voltage using the supply voltage. That is, the bandgap circuit generates a near-constant voltage, with little change in the voltage as a result of changes in the power supply, electrical load, or temperature. The power supply is used to power the bandgap circuit, and due to the nature of the bandgap circuit, the reference voltage produced is near-constant regardless of the power provided by the power supply. Nevertheless, the reference voltage may deviate from an expected value due to start-up fluctuations, insufficient power provided by the power supply and/or damage to the bandgap circuit.

To perform the monitoring, the circuit comprises a gain component configured to receive the reference voltage and the supply voltage, and to provide an output voltage equal to the smaller of (i) the reference voltage multiplied by a gain value, and (ii) the supply voltage.

Accordingly, the gain component receives the reference voltage and scales it by the gain value. It may then compare the scaled reference voltage to the supply voltage to determine which of the scaled reference voltage and the supply voltage are smaller. Based on the comparison, the gain component provides, generates or otherwise outputs an output voltage equal to the smaller of the scaled reference voltage and the supply voltage.

The circuit further comprises a comparison circuit that receives the output voltage from the gain component. The comparison circuit compares the output voltage to a trigger value, and provides first or second information (e.g., either outputs a high-state voltage or a low-state voltage) based on the comparison.

If the output voltage meets or exceeds the trigger value, then first information is provided by the comparison circuit. That is, if a magnitude of the output voltage is greater than or equal to the trigger value, then the comparison circuit will output first information. The first information indicates that the reference voltage meets a reference threshold value, and the supply voltage meets a supply threshold value.

If the output voltage fails to meet the trigger value, then second information is provided by the comparison circuit. That is, if a magnitude of the output voltage is smaller than the trigger value, then the comparison circuit will output second information. The second information indicates that either the reference voltage fails to meet the reference threshold value, and/or the supply voltage fails to meet the supply threshold value.

In some embodiments, the first information may be provided in the form of a high-state signal, and the second information may be provided in the form of a low-state signal. For example, the comparison circuit may output a voltage corresponding to a “1” as first information, and may output a voltage corresponding to a “0” as second information. That is, the comparison circuit may pull an output node to a high-state when it is determined that the output voltage meets a trigger value, or may pull the output node to a low-state when it is determined that the output voltage fails to meet a trigger value. Of course, the opposite of the above may be true (i.e., the first information may be provided in the form of a low-state signal, and the second information may be provided in the form of a high-state signal).

The supply threshold value may be a minimum desired magnitude of the supply voltage. This may be a minimum voltage required to reliably, safely, and/or predictably power a load to which the power supply is providing power.

The reference threshold value may be a minimum desired magnitude of the reference voltage. This value may be set to be the minimum of the expected voltage output by the bandgap circuit when operating in expected conditions. That is, this value may be the minimum voltage expected to be output by the bandgap circuit, given that the bandgap circuit is operating in a steady state (i.e., not during start-up), with an adequate supply, and when it is not damaged.

In typical embodiments, the supply threshold value is greater than the reference threshold value. In one case, the supply threshold value may be between 1.44V and 1.62V, and the reference threshold value may be between 1.05V and 1.15V.

In some embodiments, the gain value (used to scale the reference voltage) may depend on the supply threshold value and the reference threshold value. That is, the gain value may be set based on the supply threshold value and the reference threshold value. More specifically, the gain value may be equal to the supply threshold value divided by the reference threshold value. In this case, the trigger value may be equal to the supply threshold value.

In a specific embodiment, the comparison circuit may comprise an open loop bandgap (OLBG) circuit and a comparator.

The OLBG circuit may be configured to receive the output voltage from the gain component, and to generate a first voltage and a second voltage, wherein the difference between the first voltage and the second voltage is based on the received output voltage from the gain component. That is, the OLBG may be configured to output two voltages, the difference between which depends on the magnitude of the output voltage.

The comparator may be configured to output either the first information or the second information based on a result of a comparison between the first voltage and the second voltage. In other words, if the difference between the first voltage and the second voltage meets (or exceeds) a certain condition, then the first information may be output. Alternatively, if the difference between the first voltage and the second voltage fails to meet the certain condition, then the second information may be provided.

This combination of the OLBG circuit and the comparator circuit enables the determination of whether the output voltage from the gain component meets the trigger value, without need for an externally generated reference voltage. Indeed, these components are configured such that they provide first information if the output voltage meets or exceeds the trigger value, and the second information if the output voltage fails to meet the trigger value. This is facilitated primarily by the OLBG circuit, which generates two voltages whose difference is based on the output voltage from the gain component.

In other words, as the OLBG circuit does not require an external reference voltage, nor a supply voltage (other than that of the output voltage from the gain component), this comparison circuit may provide first or second information reliably independent of the condition of the supply voltage.

To be more specific, the OLBG circuit may comprise an input node connected to the output of the gain component.

The OLBG circuit may include a first leg comprising a first resistor and a second resistor connected in series between the input node and a reference potential node (e.g., ground), and a diode connected in parallel with the second resistor of the first leg and between the reference potential node and a first output node. The first output node may be provided between the first and second resistor of the first leg, and the diode may be configured to obstruct flow of current between the reference potential node and the first output node. The first voltage may be provided on the first output node.

The OLBG circuit may also include a second leg comprising a first resistor and a second resistor connected in series between the input node and the reference potential node. The second leg may also comprise a diode and a third resistor connected in series, with the diode and third resistor connected in parallel with the second resistor of the second leg and between the reference potential node and a second output node. The second output node may be provided between the first and second resistor of the second leg. The diode may be configured to obstruct flow of current between the reference potential node and the second output node. In this case, the second voltage may be provided on the second output node.

Of course, other configurations and modifications of the OLBG circuit may be implemented by the skilled person, and further components may be provided in the OLBG circuit.

Whilst the comparison circuit comprising the OLBG circuit and comparator are desirable, other configurations of the comparison circuit are envisioned.

By way of example, the comparison circuit may comprise a voltage divider and a comparator. More specifically, the comparison circuit may comprise an input node connected to the output of the gain component, and a voltage divider (e.g., a first resistor and second resistor connected in series) connected between the input node and a reference potential node (e.g., ground). The voltage divider may be configured to provide an output voltage based on the voltage on the input node. The comparator may be configured to output either the first information or the second information based on a result of a comparison between the output voltage from the voltage divider, and a comparator reference voltage.

Of course, this comparison circuit requires a comparator reference voltage which may be generated via another source. Nevertheless, it will be appreciated that this comparison circuit still provides a means for monitoring both the supply voltage from the power supply and the reference voltage from the bandgap circuit, using one comparison circuit (e.g., not requiring additional components for monitoring the power supply and the bandgap circuit). Indeed, the voltage divider provides a means for stepping down the output voltage from the gain component in a way that a reliable assessment of the operation of the power supply and bandgap circuit may still be made in low-voltage conditions.

To summarize, the present disclosure provides a means for monitoring a supply voltage of a power supply, and a reference voltage from a bandgap circuit (which should be substantially fixed independent of voltage fluctuations of the power supply and temperature conditions) using one simple circuit. Specifically, by use of the gain component that provides an output voltage equal to the smaller of (i) the reference voltage multiplied by a gain value, and (ii) the supply voltage, a single comparison circuit can be provided that assess the output voltage from the gain component to assess whether the power supply and bandgap circuit are operating as expected.

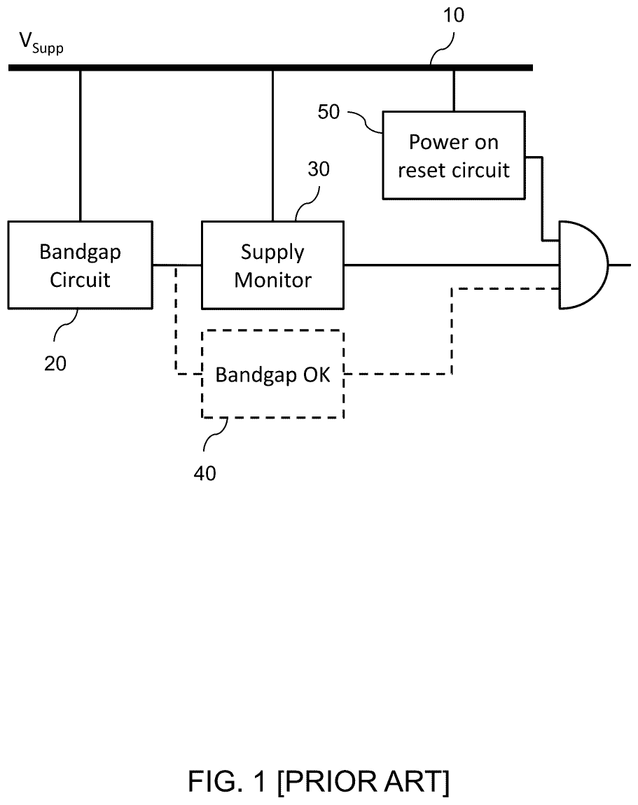

To best understand advantages of disclosed embodiments, it is useful to understand how power supplies are currently monitored. One such system is depicted in FIG. 1.

As shown, there is a power supply 10 that is configured to provide a supply voltage, V_{Supp}. The power supply 10 may be used to provide power for another system. The power supply 10 is connected to a bandgap circuit 20. As described above, the bandgap circuit 20 is a voltage reference circuit that produces a near-constant reference voltage, V_{Ref}, using the supply voltage, V_{Supp}.

In order to monitor the magnitude of the supply voltage. V_{Supp}, there is provided a supply monitor 30. The supply monitor 30 receives V_{Supp} from the power supply 10, and V_{Ref} from the bandgap circuit 20. By comparison of V_{Supp} and V_{Ref}, it can be determined whether V_{Supp} meets minimum requirements. If not, then the supply monitor 30 will indicate that there is a low supply.

A power on reset circuit 50 may also be provided. The power on reset circuit 50 ensures that V_{Supp} is providing a high supply. That is, the supply monitor 30 indicates whether V_{Supp} meets a minimum supply level, and the power on reset circuit 50 indicates whether V_{Supp} is providing a high supply. If both are satisfied then the power supply 10 is providing an appropriate supply voltage.

However, problems may arise if the bandgap circuit 20 fails to provide an accurate V_{Ref}. This may be due to damage to the bandgap circuit 20, or may be related to the power supply 10. For example, during start-up of the power supply 10, it may take time for the bandgap circuit 20 to settle and to provide a stable and accurate V_{Ref}. In some cases, the voltage provided by the power supply 10 may be inadequate for stable and accurate generation of V_{Ref}. In these cases, the provided monitoring system may not provide a correct indication of whether the power supply 10 is providing an adequate V_{Supp}.

There may therefore be provide a bandgap ok circuit 40. This circuit may monitor V_{Ref}, and provide an indication whether V_{Ref} is accurate and stable. However, it will be appreciated that this requires additional space, requires more components and cost, and itself may be prone to error.

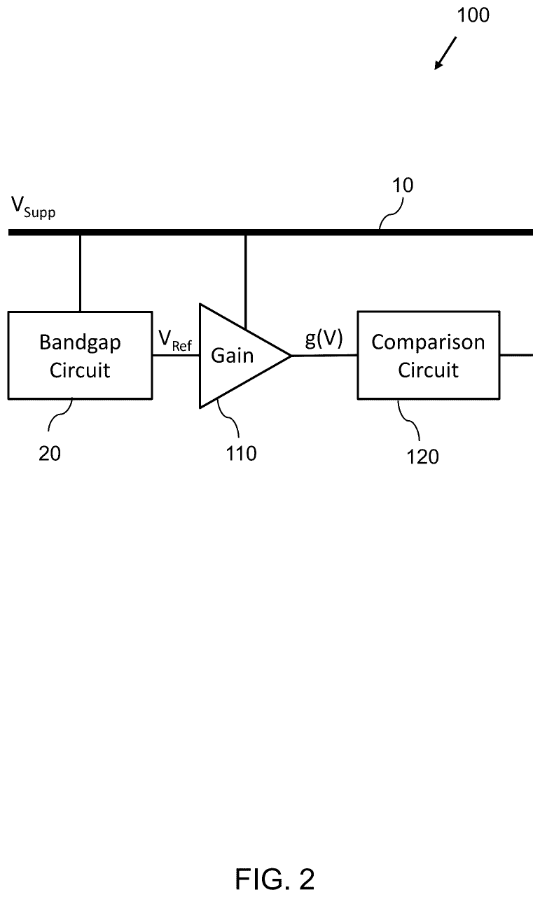

A solution according to proposed embodiments is depicted in FIG. 2. That is, FIG. 2 presents a circuit for monitoring a power supply 10 and a bandgap circuit 20 according to an embodiment. This circuit may provide an indication of whether or not the power supply 10 and the bandgap circuit 20 are providing expected voltages.

As shown, the circuit comprises a gain component 110 and a comparison circuit 120. The gain component 110 receives the supply voltage, V_{Supp}, and the reference voltage V_{Ref}, and provides an output voltage, g(V), to the comparison circuit 120. The comparison circuit 120 receives g(V), and provides either first information or second information.

The gain component 110 is configured to provide g(V) equal to the smaller of the V_{Ref} multiplied by a gain value, A, and V_{Supp}. To this end, the gain component 110 may first scale the V_{Ref} by the gain value. Then, the gain component 110 may compare the scaled V_{Ref} with V_{Supp} and output the smaller of the two voltages.

The comparison circuit 120 is configured, responsive to g(V) meeting a trigger value, to provide first information indicating that V_{Ref} meets a reference threshold value, V_{trig_ref} and that V_{Supp} meets a supply threshold value, V_{trig_supp}. Alternatively, responsive to g(V) failing to meet a trigger value, the comparison circuit 120 is configured to provide second information indicating that V_{Ref} fails to meet a reference threshold value, V_{trig_ref} and/or that V_{Supp} fails to meet a supply threshold value, V_{trig_supp}. Accordingly, the output from the comparison circuit 120 shows whether the bandgap circuit 20 and the power supply 10 are performing as expected.

In other words, the gain component 110 may be configured to perform the following:
if A*V_{Ref}<V_{Supp}, then g(V)=A*V_{Ref}
else g(V)=V_{Supp}
   where A=V_{trig_supp}/V_{trig_ref}.

The comparison circuit 120 then compares g(V) to a trigger value. If g(V) meets or exceeds the trigger value, then the comparison circuit 120 may output first information (e.g., may output a high value). If g(V) fails to meet the trigger value, then the comparison circuit 120 may output second information (e.g., may output a low value). The trigger value may be equal to V_{trig_supp}.

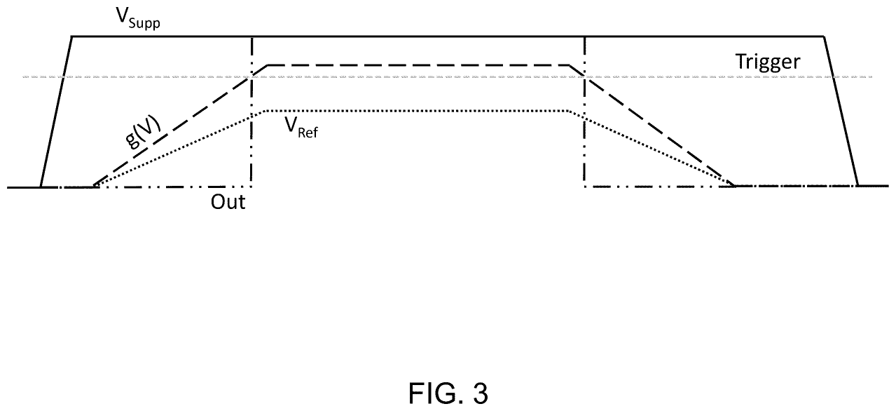

To demonstrate operation of this circuit, FIG. 3 depicts an example response of the circuit during a fast start-up of the power supply 10. Equally, the response shown in FIG. 3 may equally apply to a scenario where the bandgap circuit 20 is slow to start up.

As shown, the power supply 10 starts up and V_{Supp} rises rapidly before stabilizing at an expected magnitude. However, V_{Ref} output by the bandgap circuit 20 remains at 0 output, either because the power supply 10 started and stabilized rapidly, or because the bandgap circuit 20 takes a while to start up.

Accordingly, g(V) remains at 0, because it is equal to the lower of V_{Ref}*A (i.e., 0), or V_{Supp}. As a result, the output from the comparison circuit 120 also stays low (indicating second information). It is worth noting that in other monitoring circuits, it may be indicated that the circuit is operating normally as V_{Supp} exceeds V_{Ref}, despite the fact that the bandgap circuit 20 has not yet started.

After time, the bandgap circuit 20 starts up, and V_{Ref} begins to rise. Accordingly, g(V) also begins to rise. Eventually, g(V) reaches a trigger value. When this occurs, the output from the comparison circuit 120 switches high (indicating first information).

After operation for a time, the bandgap circuit 20 gets damaged, and V_{Ref} begins decreasing. Once, g(V) falls below the trigger value, the output from the comparison circuit 120 switches low (indicating second information). It is worth noting that in other monitoring circuits, it may be indicated that the circuit is operating normally until V_{Supp} eventually decreases (i.e., the power supply 10 turns off), as V_{Supp} exceeds V_{Ref}, despite the fact that the bandgap circuit 20 has been damaged.

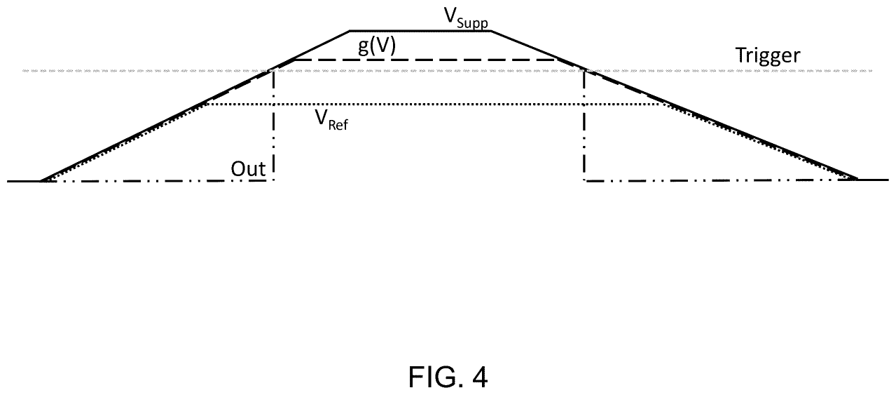

A further example demonstrating operation of the circuit is shown in FIG. 4. In this case, the power supply 10 is slow to start-up and to start providing an adequate V_{Supp}.

As shown, the power supply 10 starts up and V_{Supp} rises slowly. Due to this slow rise, V_{Ref} also rises at substantially the same time. Accordingly, g(V) is equal to V_{Supp}, as V_{Ref}* A is greater than V_{Supp.}

After a time, V_{Ref} reaches its expected output value. g(V) continues to rise, as V_{Supp} remains smaller than V_{Ref}*A. It is worth noting that in other monitoring circuits, it may be indicated that the circuit is operating normally as V_{Supp} exceeds V_{Ref}, despite the fact that Vₛᵤₚₚ has not yet reached V_{trig_supp}.

Eventually, g(V) (still equal to V_{Supp}) reaches the trigger value. At this point, the output from the comparison circuit 120 switches high (indicating first information). g(V) continues to rise for a short time as Vₛᵤₚₚ is still less than A*V_{Ref}. Eventually g(V) settles at A*V_{Ref}.

After some time, the power supply 10 is switched off. V_{Supp} begins to decrease whilst V_{Ref} remains stable, as well as g(V). Eventually, Vₛᵤₚₚ is less than A*V_{Ref}, and g(V) falls below the trigger level. At this point, the output from the comparison circuit 120 switches low (indicating second information).

As shown by these scenarios, the monitoring circuit provides a reliable way for indicating when both the power supply 10 and bandgap circuit 20 are operating as expected, and when at least one of the two are not.

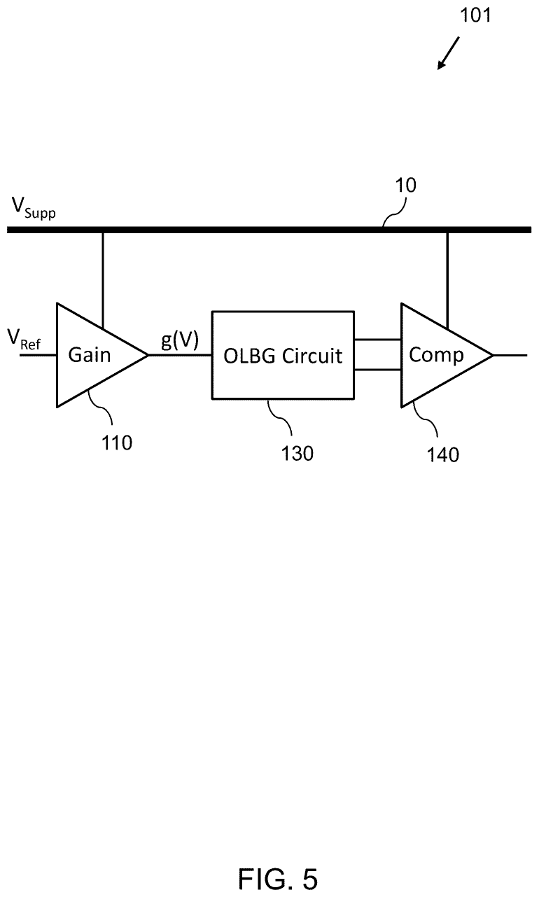

FIG. 5 presents a circuit for monitoring a power supply 10 and a bandgap circuit 20 according to a further embodiment. This circuit is substantially in terms of operation as the circuit of FIG. 2. Repeated description of the gain component 110 is therefore omitted for sake of brevity. However, the comparison circuit 120 in this case is implemented in the form of an OLBG circuit 130 and a comparator 140.

The OLBG circuit 130 is configured to receive g(V) from the gain component 110, and to generate a first voltage and a second voltage. A difference in magnitude between the generated first voltage and second voltage is based on g(V). Accordingly, the difference between these voltages provides a means for assessing the magnitude of g(V), without need for an external reference voltage.

The comparator 140 is configured to output either the first information or the second information based on a result of a comparison between the first voltage and the second voltage. That is, the comparator 140 assesses the difference between the first voltage and second voltage from the OLBG circuit 130, and either outputs first information or second information depending on the difference. For example, if the difference exceeds a certain magnitude then first information may be provided, and if the difference does not exceed a certain magnitude then second information may be provided (or visa versa).

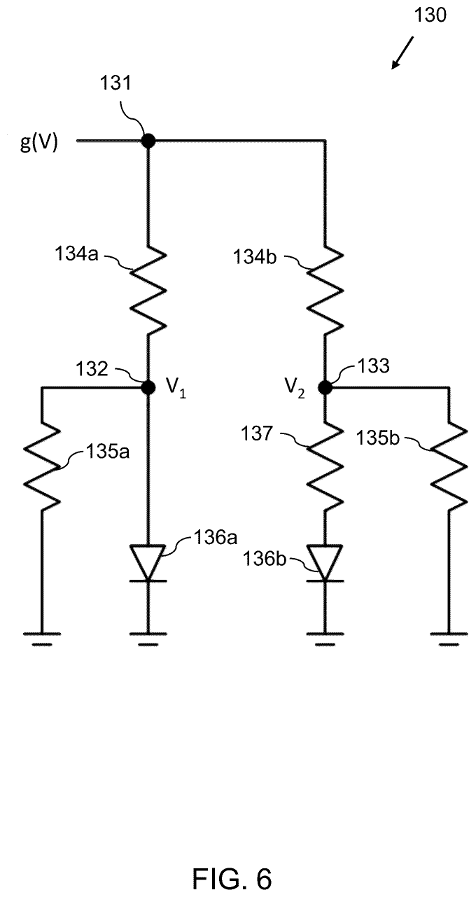

FIG. 6 presents a circuit diagram of an OLBG circuit 130 that may be implemented in the circuit of FIG. 5.

As shown, the OLBG circuit 130 comprises an input node 131 connected to the output of the gain component 110. The input node 131 therefore receives g(V). The OLBG circuit 130 comprises a first leg for providing the first voltage V₁ at a first output node 132, and a second leg for providing the second voltage V₂ and a second output node 133.

The first leg comprises a first resistor 134a, a second resistor 135a, and a diode 136a. The first resistor 134a and the second resistor 135a are connected in series between the input node and ground. The diode 136a is connected in parallel with the second resistor 135a, and between ground and a first output node 132. The first output node 132 is provided between the first resistor 134a and the second resistor 135a. That is, the diode 136a and second resistor 135a are arranged in parallel between the first output node 132 and ground. The diode 136a is arranged to obstruct flow of current between ground and the first output node 132.

The second leg comprises a first resistor 134b, a second resistor 135b, a third resistor 137, and a diode 136b. The first resistor 134b and the second resistor 135b are connected in series between the input node and ground. The diode 136b and the third resistor 137 connected in series, and arranged in parallel with the second resistor 135b, between ground and a second output node 133. The second output node 133 is provided between the first and second resistor 135b of the second leg. The diode 136b is arranged to obstruct flow of current between ground and the second output node 133 (via the third resistor 137).

The resistance of the first resistor 134a of the first leg and the first resistor 134b of the second leg may be the same. The resistance of the second resistor 135a of the first leg and the second resistor 135b of the second leg may be the same. A circuit trigger point of the OLBG circuit 130 may be defined as when the first voltage and the second voltage are equal. That is, if the voltage on the input node 131 (i.e., g(V)) is equal to predetermined voltage, then the first voltage and second voltage may be equal. This predetermined voltage can be defined by the ratio of the resistance of the first resistors 134a, 134b, and the resistance of the third resistor 137.

Accordingly, these resistances may be selected such that the difference between the first voltage and second voltage is negative when g(V) is less than a trigger value, and positive when g(V) is equal to or greater than the trigger value (or visa versa). The comparator 140 may be configured accordingly to provide appropriate first or second information.

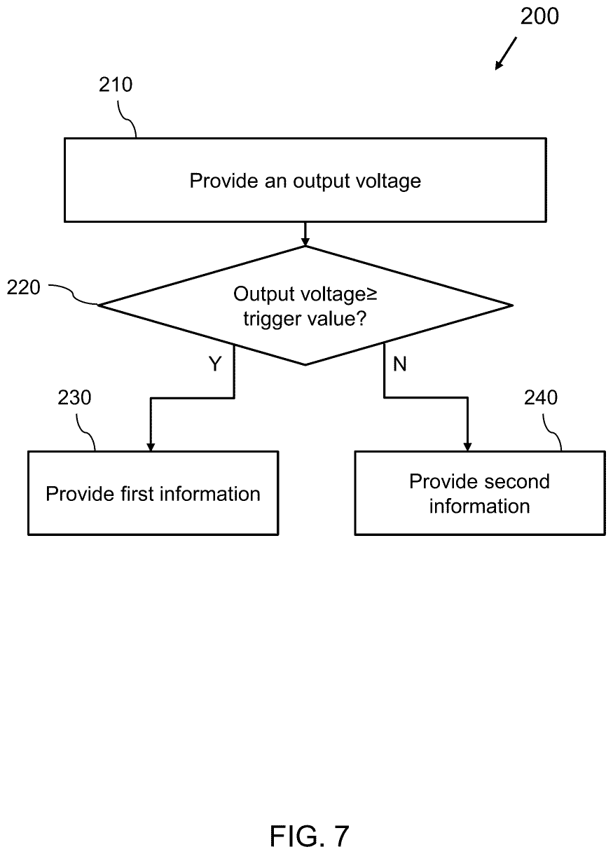

FIG. 7 presents a flow diagram of a method for monitoring a power supply and a bandgap circuit. As described above, the power supply is configured to provide a supply voltage. The bandgap circuit is configured to generate a substantially fixed reference voltage using the supply voltage.

In step, 210 an output voltage is provided that is equal to the smaller of the reference voltage from the bandgap circuit multiplied by a gain value and the supply voltage. To this end, there may be provided a subset of multiplying/scaling the reference voltage by the gain value before comparison between the scaled reference voltage and the supply voltage to determine the smaller of the two.

The gain value may depend on a supply threshold value (indicating a minimum desired magnitude of the supply voltage) and a reference threshold value (indicating a minimum desired magnitude of the threshold voltage. Specifically, the gain value may be equal to the supply threshold value divided by the reference threshold value. The supply threshold value may be greater than the reference threshold value.

In step 220, it is determined whether the output voltage provided in step 210 meets a trigger value. That is, it is determined whether the magnitude of the output voltage is greater than or equal to the trigger value. If it is, then the method proceeds to step 230. If not, then the method proceeds to step 240.

In step 230, first information is provided/output. The first information indicates that the reference voltage meets a reference threshold value, and the supply voltage meets a supply threshold value. That is, the first information indicates that both the power supply and the bandgap circuit are operating as expected.

In step 240, second information is provided/output. The second information indicates that either the reference voltage fails to meet the reference threshold value, and/or the supply voltage fails to meet the supply threshold value. That is, at least one (or both) of the power supply and bandgap circuit are providing an unexpected voltage.

Steps 210-240 may be repeated iteratively as the supply voltage and reference voltage change. Thus, the supply voltage and threshold voltage may be continually monitored to ensure they meet requirements.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

The following embodiments are disclosed:
1. A circuit for monitoring a power supply configured to provide a supply voltage, and for monitoring a bandgap circuit configured to generate a substantially fixed reference voltage using the supply voltage, the circuit comprising:
   a gain component configured to receive the reference voltage and the supply voltage, and to provide an output voltage equal to the smaller of the reference voltage multiplied by a gain value, and the supply voltage; and
   a comparison circuit configured:
responsive to the output voltage meeting a trigger value, to provide first information indicating that the reference voltage meets a reference threshold value, and the supply voltage meets a supply threshold value; and
responsive to the output voltage failing to meet the trigger value, to provide second information indicating that either the reference voltage fails to meet the reference threshold value, and/or the supply voltage fails to meet the supply threshold value.
2. The circuit of embodiment 1, wherein the gain value depends on the supply threshold value and the reference threshold value.
3. The circuit of embodiment 2, wherein the gain value is equal to the supply threshold value divided by the reference threshold value.
4. The circuit of any of embodiments 1-3 further comprising the bandgap circuit configured to generate the substantially fixed reference voltage using the supply voltage.
5. The circuit of any of embodiments 1-4, wherein the supply threshold value is greater than the reference threshold value.
6. The circuit of any of embodiments 1-5, wherein the comparison circuit comprises:
   an open loop bandgap, OLBG, circuit configured to receive the output voltage from the gain component, and to generate a first voltage and a second voltage, wherein the difference between the first voltage and the second voltage is based on the received output voltage from the gain component; and
   a comparator configured to output either the first information or the second information based on a result of a comparison between the first voltage and the second voltage.
7. The circuit of embodiment 6, wherein the OLBG circuit comprises: an input node connected to the output of the gain component;
   a first leg comprising a first resistor and a second resistor connected in series between the input node and a reference potential node, and a diode connected in parallel with the second resistor of the first leg and between the reference potential node and a first output node, the first output node provided between the first and second resistor of the first leg, the diode configured to obstruct flow of current between the reference potential node and the first output node, wherein the first voltage is provided on the first output node;
   a second leg comprising a first resistor and a second resistor connected in series between the input node and the reference potential node, and a diode and a third resistor connected in series, the diode and third resistor connected in parallel with the second resistor of the second leg and between the reference potential node and a second output node, the second output node provided between the first and second resistor of the second leg, the diode configured to obstruct flow of current between the reference potential node and the second output node, wherein the second voltage is provided on the second output node.
8. The circuit of any of embodiments 1-5, wherein the comparison circuit comprises:
   an input node connected to the output of the gain component;
   a voltage divider connected between the input node and a reference potential node, and configured to provide an output voltage based on the voltage on the input node; and
   a comparator configured to output either the first information or the second information based on a result of a comparison between the output voltage from the voltage divider, and a comparator reference voltage.
9. The circuit of embodiment 8, wherein the voltage divider comprises a first resistor and a second resistor connected in series.
10. The circuit of any of embodiments 7-9, wherein the reference potential node is connected to ground.
11. A method for monitoring a power supply configured to provide a supply voltage and for monitoring a bandgap circuit configured to generate a substantially fixed reference voltage using the supply voltage, the method comprising:
   providing an output voltage equal to the smaller of the reference voltage multiplied by a gain value and the supply voltage;
   responsive to the output voltage meeting a trigger value, providing first information indicating that the reference voltage meets a reference threshold value, and the supply voltage meets a supply threshold value; and
   responsive to the output voltage failing to meet the trigger value, providing second information indicating that either the reference voltage fails to meet the reference threshold value, and/or the supply voltage fails to meet the supply threshold value.
12. The circuit of embodiment 11, wherein the gain value depends on the supply threshold value and the reference threshold value.
13. The circuit of embodiment 12, wherein the gain value is equal to the supply threshold value divided by the reference threshold value.
14. The circuit of any of embodiments 11-13, wherein the supply threshold value is greater than the reference threshold value.

What is claimed is:

1. A circuit for monitoring a power supply configured to provide a supply voltage, and for monitoring a bandgap circuit configured to generate a substantially fixed reference voltage using the supply voltage, the circuit comprising:
a gain component configured to receive the reference voltage and the supply voltage, and to provide an output voltage equal to a smaller of the reference voltage multiplied by a gain value, and the supply voltage; and
a comparison circuit configured:
responsive to the output voltage meeting a trigger value, to provide first information indicating that the reference voltage meets a reference threshold value, and the supply voltage meets a supply threshold value; and
responsive to the output voltage failing to meet the trigger value, to provide second information indicating that the reference voltage fails to meet the reference threshold value or the supply voltage fails to meet the supply threshold value.

2. The circuit of claim 1, wherein the gain value depends on the supply threshold value and the reference threshold value.

3. The circuit of claim 2, wherein the gain value is equal to the supply threshold value divided by the reference threshold value.

4. The circuit of claim 1, further comprising the bandgap circuit configured to generate the substantially fixed reference voltage using the supply voltage.

5. The circuit of claim 1, wherein the supply threshold value is greater than the reference threshold value.

6. The circuit of claim 1, wherein the comparison circuit comprises:
an open loop bandgap (OLBG) circuit configured to receive the output voltage from the gain component, and to generate a first voltage and a second voltage, wherein a difference between the first voltage and the second voltage is based on the received output voltage from the gain component; and
a comparator configured to output either the first information or the second information based on a result of a comparison between the first voltage and the second voltage.

7. The circuit of claim 6, wherein the OLBG circuit comprises:
an input node connected to the output of the gain component;
a first leg comprising a first resistor and a second resistor connected in series between the input node and a reference potential node, and a diode connected in parallel with the second resistor of the first leg and between the reference potential node and a first output node, the first output node provided between the first and second resistor of the first leg, the diode configured to obstruct flow of current between the reference potential node and the first output node in a first direction, wherein the first voltage is provided on the first output node; and
a second leg comprising a first resistor and a second resistor connected in series between the input node and the reference potential node, and a diode and a third resistor connected in series, the diode and third resistor connected in parallel with the second resistor of the second leg and between the reference potential node and a second output node, the second output node provided between the first and second resistor of the second leg, the diode configured to obstruct flow of current between the reference potential node and the second output node in the first direction, wherein the second voltage is provided on the second output node.

8. The circuit of claim 7, wherein the reference potential node is connected to ground.

9. The circuit of claim 1, wherein the comparison circuit comprises:
an input node connected to the output of the gain component;
a voltage divider connected between the input node and a reference potential node, and configured to provide an output voltage based on the voltage on the input node; and
a comparator configured to output either the first information or the second information based on a result of a comparison between the output voltage from the voltage divider, and a comparator reference voltage.

10. The circuit of claim 9, wherein the voltage divider comprises a first resistor and a second resistor connected in series.

11. A method for monitoring a power supply configured to provide a supply voltage and for monitoring a bandgap circuit configured to generate a substantially fixed reference voltage using the supply voltage, the method comprising:
providing an output voltage equal to the smaller of the reference voltage multiplied by a gain value and the supply voltage;
responsive to the output voltage meeting a trigger value, providing first information indicating that the reference voltage meets a reference threshold value, and the supply voltage meets a supply threshold value; and
responsive to the output voltage failing to meet the trigger value, providing second information indicating that the reference voltage fails to meet the reference threshold value or the supply voltage fails to meet the supply threshold value.

12. The method of claim 11, wherein the gain value depends on the supply threshold value and the reference threshold value.

13. The method of claim 12, wherein the gain value is equal to the supply threshold value divided by the reference threshold value.

14. The method of claim 11, wherein the supply threshold value is greater than the reference threshold value.

15. The method of claim 11, further comprising providing the supply voltage using the power supply.

16. A supply monitoring circuit, comprising:
an amplifier having a signal input configured to receive an reference voltage and a supply input configured to receive a power supply voltage;
an open loop bandgap circuit comprising an input node coupled to an output of the amplifier, a first diode and a second diode; and
a comparator having a first input coupled to the first diode and a second input coupled to the second diode.

17. The supply monitoring circuit of claim 16, wherein the open loop bandgap circuit comprises:
a first resistor coupled between the input node and a first node of the first diode at a first output node, wherein a second node of the first diode is coupled to a supply reference node;
a second resistor coupled between the first output node and the supply reference node;
a third resistor coupled in series with the second diode to form a first series circuit, wherein the first series circuit is coupled between a second output node and the supply reference node;
a fourth resistor coupled between the input node and the second output node; and
a fifth resistor coupled between the second output node and the supply reference node.

18. The supply monitoring circuit of claim 17, wherein the first input of the comparator is connected to the first output node and the second input of the comparator is connected to the second output node.

19. The supply monitoring circuit of claim 18, wherein:
the first resistor and the fourth resistor have a same first resistance; and
the second resistor and the fifth resistor have a same second resistance.

20. The supply monitoring circuit of claim 16, wherein an output of the comparator is configured to be indicative of whether both the reference voltage and the power supply voltage meet a predetermined minimum voltage.
